(19) United States
(12) Patent Application Publication
(10) Pub. No.: US 2014/0066565 A1
(43) Pub. Date: Mar. 6, 2014

(54) POLYPROPYLENE-POLYLACTIC ACID RESIN COMPOSITION

(71) Applicant: Samsung Total Petrochemicals Co., Ltd., Chungcheongnam-do (KR)

(72) Inventors: Jin Seong JEONG, Chungcheongnam-do (KR); Do Hoon LEE, Chungcheongnam-do (KR); Young Joo LEE, Incheon (KR)

(73) Assignee: Samsung Total Petrochemicals Co., Ltd., Chungcheongnam-do (KR)

(21) Appl. No.: 14/016,745

(22) Filed: Sep. 3, 2013

(30) Foreign Application Priority Data
Sep. 5, 2012 (KR) 10-2012-0098384

(51) Int. Cl. C08L 23/12; C08L 53/00

(52) U.S. Cl. CPC C08L 23/12; C08L 53/00
USPC 524/451; 525/64; 524/504

(57) ABSTRACT

The provided is a polypropylene/polylactic acid resin composition comprising a polypropylene resin, a polylactic acid resin, a reactive compatibilizer, optionally an impact modifier and an inorganic filler, having excellent heat resistance, impact resistance and flexural modulus.

### TECHNICAL FIELD

The present invention relates to a polypropylene resin composition containing a polylactic acid resin (hereinafter, referred as a ‘polypropylene/polylactic acid resin composition), specifically to a polypropylene/polylactic acid resin composition comprising a polypropylene resin, a polylactic acid resin, a reactive compatibilizer, optionally an impact modifier and an inorganic filler, having excellent heat resistance, impact resistance and flexural modulus.

### BACKGROUND ART

With the rise of issues on oil depletion or global warming, regulations on the emission of greenhouse gases including carbon dioxide have become obligatory. In this respect, approaches for seeking eco-friendly resin derived from biomass in order to replace materials such as polymers derived from oil resources have been made.

Among those eco-friendly resins, polylactic acid is an aliphatic polyester prepared by polymerization of lactic acids derived from fermentation of corn starch. Polylactic acid is a biodegradable polymer which has excellent mechanical properties, and is inexpensive and harmless, as compared to other eco-friendly plastic materials, therefore its applications have become extended to various fields including, for example, food containers, disposable products such as plastic wrap and baby products, etc. However, poor heat resistance and impact resistance of polylactic acid make its applications rather limitative as compared to other general-purpose polymers. On this grounds, studies for making up for such defects of polylactic acid have been being made, by blending it with polyolefins having excellent heat resistance. Among polyolefins, polypropylene which has better heat resistance than polyethylene may be advantageously used to improve heat resistance of polylactic acid, however said two polymers have different polarity and thus are not compatible with each other. In this respect, a method including use of compatibilizer has been majorly used.

Korean laid-open patent application No. 10-2012-0044799 suggests a resin composition having improved heat resistance and impact resistance by adding 0.5-10 parts by weight of a polypropylene-maleic anhydride copolymer or polyethylene-glycidyl methacrylate copolymer as a compatibilizer for polypropylene and polylactic acid, however, it is disclosed that the high heat deflection temperature (HDT) is only achieved when annealing is conducted at 110° C. for 2 hours. Without annealing, its examples showed HDT of 78.3° C. and 75.4° C. In the whole manufacturing process, the time taken for a production process in plant is one of very important elements, and the increase in temperature for annealing to 110° C. which is higher than the glass transition temperature of polylactic acid may lead deformation in the final product. Moreover, owing to progress of crystallization of alloy, modification in dimension may occur. Therefore, it is practically difficult to obtain the desired final product through such aging process of alloy.

Korean laid-open patent application No. 10-2011-0048125 suggests a polylactic acid-containing polymeric alloy composition suitable for a container for living, which has excellent blow molding properties and impact resistance by using a compound having at least one functional group being capable of reacting with the polylactic acid and at least one vinyl group, as a compatibilizer. The compatibilizer used therein is ethylene based copolymers such as an ethylene-(meth)acryalate glycidyl copolymer and an ethylene-(meth)acryalate glycidyl-vinyl acetate copolymer. The polylactic acid-containing polymer alloy composition is characterized by improved melt viscosity, impact strength and elongation, however it does not consider heat deflection temperature at all.

US published patent application No. US2010/0160564 A1 suggests a complex resin composition comprising polypropylene, polylactic acid and an elastomer with the specific use of an ethylene polymer having an epoxy group as a compatibilizer, which has excellent impact strength. However, there is not any description regarding heat deflection temperature.

### SUMMARY OF THE INVENTION

The object of the present invention is to provide a polypropylene/polylactic acid resin composition having high heat resistance and excellent balanced mechanical properties even without an aging step.

### DETAILED DESCRIPTION OF THE PRESENT INVENTION

The present invention which has been designed to solve the above-mentioned object, provides a polypropylene/polylactic acid resin composition comprising (A) 40-80 parts by weight of a polypropylene resin, (B) 10-45 parts by weight of a polylactic acid resin, and (C) 3-30 parts by weight of a reactive compatibilizer.

The resin composition of the present invention may further comprise (D) 20 parts by weight or less of an impact modifier and (E) 20 parts by weight or less of an inorganic filler.

Hereinafter, the components contained in the polypropylene/polylactic acid resin composition of the present invention are further described in detail as follows.

(A) Polypropylene Resin

As for the polypropylene resin, at least one selected from the group consisting of a propylene homopolymer, a propylene block copolymer and a propylene random copolymer may be used, wherein the melt index thereof is preferably 0.5-30 g/10 min(ASTM D1238, 230° C., 2.16 kg). Among those, a propylene homopolymer is preferred in terms of heat resistance, and more preferred is a propylene block copolymer which can impart balanced heat resistance and impact resistance.

The polypropylene resin is preferably used at the amount of 40-80 parts by weight, wherein when the amount of the polypropylene resin is less than 40 parts by weight, the polypropylene resin content used in the main matrix material is low, while the content of polylactic acid resin is high, and thus the heat resistance becomes greatly decreased; in the meantime when the amount of the polypropylene resin is more than 80 parts by weight, it is not classified as a eco-friendly resin owing to the decreased polylactic acid content.

(B) Polylactic Acid Resin

The polylactic acid resin used in the present invention is an aliphatic polyester resin, which is a biodegradable polymer synthesized from condensation polymerization of lactic acids originated from corn starch or potato starch, or ring-opening polymerization of lactide.

As the above-described polylactic acid resin, at least one selected from the group consisting of poly-L-lactic acid, poly-D-lactic acid and poly-(D,L)-lactic acid is preferably used. A polylactic acid resin with a high optical purity is preferred, and a polylactic acid resin with 95% or more of an optical purity is particularly preferred, since the crystallization speed becomes quicker and the heat resistance becomes better when the optical purity is higher.

Although the molecular weight of the polylactic acid resin used in the present invention or the molecular weight distribution thereof is not specifically limited as long as injection molding is possible, the weight average molecular weight is preferably in the range of 50,000-400,000 g/mol, and more preferably 100,000-400,000 g/mol in order to further raise mechanical strength of a resulting molded article.

The polylactic acid resin is preferably used at the amount of 10-45 parts by weight based on the total weight of the whole resin composition, wherein when the amount of the polylactic acid is less than 10 parts by weight, it only has very few biomass and thus is not so eco-friendly; in the meantime when the amount of the polylactic acid is more than 45 parts by weight, a phase inversion occurs owing to the relatively lowered polypropylene content and increased polylactic acid content, thus the polylactic acid becomes a matrix leading to significant decrease in heat resistance.

(C) Reactive Compatibilizer

A blend of two non-compatible polymer generally has a great dimension of the dispersed phase and the adhesion between the interface is weak, thereby having decreased mechanical properties. Likewise, owing to the polarity differences between a non-polar polypropylene resin and a polar polylactic acid resin, the compatibility is lowered. In this respect, a reactive compatibilizer may be introduced thereinto so as to improve the compatibility of two polymers as well as the mechanical properties.

The reactive compatibilizer used in the present invention refers to a polymer having a chemical functional group which can react with a hydroxyl group or a carboxyl group at terminal of the polylactic acid resin.

For the reactive compatibilizer, a polypropylene graft copolymer represented by the following general formula, which has a chemical functional group capable of reacting with the hydroxyl group or the carboxyl group at terminal of the polylactic acid may be used:

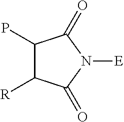

P: polypropylene, R: saturated or unsaturated C1-5 hydrocarbon chain,

E: C1-10 hydroxyalkyl, aminoalkyl or carboxyalkyl.

For the specific example of the reactive compatibilizer, at least one selected from the group consisting of polypropylene-glycidyl methacrylate graft copolymer, polypropylene-N-(hydroxyalkyl)maleimide graft copolymer, polypropylene-N-(carboxyalkyl)maleimide graft copolymer and polypropylene-N-(aminoalkyl)maleimide graft copolymer is preferred.

As for the method for preparing the reactive compatibilizer, a method of using an extruder or a preparation method on a solution phase may be used.

The method of using an extruder which is known as a reactive extrusion is a method of grafting monomers with a chemical functional group to a polypropylene backbone chain by using a radical derived from an initiator in the extruder. By the reactive extrusion, it is possible to easily carry out the production in a mass-production scale, however it also have a few disadvantages such as partial degradation owing to the initiator and the low graft ratio.

The preparation method on a solution phase is a method which comprises dissolving a polypropylene resin in a solvent and then injecting an initiator thereto so as to graft monomers having chemical functional groups. By using this method, it is possible to obtain higher graft ratio as compared to those prepared by the reactive extrusion and to remove unreacted monomers.

The amount of the reactive compatibilizer used in the present invention is preferably 3-30 parts by weight. When the amount of the reactive compatibilizer is less than 3 parts by weight, the amount of the chemical functional groups capable of reacting with the polylactic acid resin is small, thereby degrading the compatibility between the polypropylene resin and the polylactic acid resin and further significantly decreasing the mechanical properties, disadvantageously; in the meantime, when the amount of the reactive compatibilizer is more than 30 parts by weight, the content of the polypropylene resin and the polylactic acid resin becomes lowered, leading to decrease in mechanical properties as well as being undesirable in the aspect of economy.

(D) Impact Modifier

As for the impact modifier used in the present invention is preferably at least one selected from the group consisting of an amorphous ethylene-α-olefin copolymer, an ethylene propylene diene copolymer (EPDM), a styrene thermoplastic elastomer and an acryl copolymer.

Examples of the α-olefin component in the amorphous ethylene-α-olefin copolymer include propylene, 1-butene, 1-hexene, 1-octene and the like. Further, as for the examples of the styrene thermoplastic elastomer, styrene-butadiene-styrene (SBS), styrene-ethylene-butylene-styrene (SEBS), styrene-ethylene-propylene-styrene (SEPS) and the like may be mentioned. As for the acryl copolymer, methylmethacrylate-butadiene-styrene (MBS) having a core-shell structure may be representatively mentioned.

The impact modifier is preferably used at the amount of 20 parts by weight or less, more preferably 5-20 parts by weight, wherein when the amount of the impact modifier is more than 20 parts by weight, the heat resistance and rigidity are significantly decreased disadvantageously, in spite of increase in the impact strength.

(E) Inorganic Filler

As for the inorganic filler used in the present invention, at least one selected from the group consisting of talc, clay, calcium carbonate (CaCO₃), glass fiber, mica, wollastonite and silica may be used. Among the above list of the inorganic fillers, talc and clay are more preferred as a nucleating agent. When such inorganic filler as listed above is added, mechanical strength and heat resistance may be improved.

The inorganic filler is used at the amount of 20 parts by weight or less, preferably 5-20 parts by weight, wherein the amount of an inorganic filler is more than 20 parts by weight, although the heat resistance and rigidity are increased, impact strength is lowered, disadvantageously.

In the polypropylene/polylactic acid resin composition of the present invention, other than the above-described components, various additives may be used together to the extent that the effect of the present invention is not harmed, for example, an antioxidant, UV stabilizer, a nucleation agent, a pigment, a flame retardant, an antistatic agent and the like.

The polypropylene/polylactic acid resin composition according to the present invention is characterized by having a heat deflection temperature before aging is 90° C. or more.

### DETAILED EMBODIMENTS OF THE INVENTION

### Examples

Hereinafter, the present invention is further illustrated in detail through the following examples, however these examples are only to illustrate the present invention without any intention to limit the scope of the present invention.

Each component used in the polypropylene/polylactic acid resin composition in the Examples and Comparative examples is described in detail as follows.

(A) Polypropylene Resin

A polypropylene homopolymer HI500 (Samsung total, melt index: 10 g/10 mins (230° C., 2.16 kg)) and polypropylene block copolymer BJ500 (Samsung total, melt index: 10 g/10 mins (230° C., 2.16 kg)) were used.

(B) Polylactic Acid Resin

Commercially available product named under 2003D manufactured by NatureWorks LLC (US) was used.

(C) Reactive Compatibilizer

A polypropylene-glycidyl methacrylate graft copolymer was manufactured by the present inventors, through a reactive extrusion of polypropylene, benzoylperoxide (an initiator) and glycidyl methacrylate (graft ratio: 1.5 wt %).

A polypropylene-N-(aminoalkyl)maleimide graft copolymer was manufactured in solution phase by the present inventors (graft ratio: 0.7 wt %).

As for the polyethylene-glycidyl methacrylate copolymer, a commercially available product named IGETABOND 2B (Sumitomo Chemical) was used.

A polypropylene-maleic anhydride copolymer was used (graft ratio: 0.7 wt %, NB1620, Samsung total).

(D) Impact Modifier

Engage 8842 (an ethylene-octene copolymer elastomer, melt index: 1 g/10 mins (190° C., 2.16 kg), from Dow chemical (US) was used.

An acryl copolymer C-223A from Mitsubishi Rayon (JAPAN) was used.

(E) Inorganic Filler

KR-8500 (average particle size: 2 μm) purchased from Kyoungi-Talc was used.

### Examples 1-5 and Comparative Examples 1-4

After the preparation of a polypropylene/polylactic acid resin composition by mixing components represented in the following table 1, it was subjected to a biaxial extruder having L/D 40 and a diameter 30 mm at the temperature ranged between 170° C. and 220° C. for extrusion, and the resulting extruded product was prepared in the form of pellet.

Assessment of Physical Properties

The pellets prepared by the above-described method in Examples 1 to 5 and Comparative examples 1 to 4 were dried at 80° C. for 4 hours, and subjected to an injection molding process by using an injection molder (TOYO) with a molding capacity of 180 tons according to ASTM standard, thereby resulting in injected products of which physical properties were to be assessed. The assessment of physical properties was determined by the following methods, and the results were shown in Table 2.

1) Tensile strength: measured according to ASTM D638.
2) Flexural modulus: measured according to ASTM D790.
3) Impact strength: measured at room temperature according to ASTM D256.
4) Heat deflection temperature (HDT): measured according to ASTM D648, before and after aging. The aging condition of the specimen was at 80° C. for 2 hours.

TABLE 1

| | Examples | | | | | Comparative examples | | | |
|---|---|---|---|---|---|---|---|---|---|
| | 1 | 2 | 3 | 4 | 5 | 1 | 2 | 3 | 4 |
| A-1 | 70 | 48 | | 50 | 70 | | | | 50 |
| A-2 | | | 50 | | | 40 | 48 | 45 | |
| B | 25 | 25 | 25 | 25 | 25 | 50 | 25 | 30 | 25 |
| C-1 | 5 | 27 | 10 | 10 | | 10 | 5 | | |
| C-2 | | | | | 5 | | | | |
| C-3 | | | | | | | | 10 | |
| C-4 | | | | | | | | | 10 |
| D-1 | | | 10 | | | | 22 | 15 | |
| D-2 | | | | 10 | | | | | 10 |
| E | | | 5 | 5 | | | | | 5 |

unit: parts by weight
*Description regarding the components
A-1: polypropylene block copolymer (BJ500, Samsung total)
A-2: polypropylene homopolymer (HI500, Samsung total)
B: polylactic acid(2003D, Natureworks)
C-1: polypropylene-glycidyl methacrylate graft copolymer (prepared by the inventors)
C-2: polypropylene-N-(aminoalkyl) maleimide graft copolymer (prepared by the inventors)
C-3: polyethylene-glycidyl methacrylate copolymer (IGETABOND 2B, Sumitomo chemical)
C-4: polypropylene-maleic anhydride coolymer (NB1620, Samsung total)
D-1: ethylene-octene copolymer (Engage 8842, Dow chemcial)
D-2: acryl copolymer (C-223A, Mitsubishi Rayon)
E: Talc (KR-8500, Kyoungi-Talc)

TABLE 2

| | Examples | | | | | Comparative examples | | | |
|---|---|---|---|---|---|---|---|---|---|
| | 1 | 2 | 3 | 4 | 5 | 1 | 2 | 3 | 4 |
| Tensile | 350 | 370 | 370 | 300 | 420 | 480 | 300 | 270 | 280 |
| strength | | | | | | | | | |
| (kgf/cm²) | | | | | | | | | |
| Flexural | 19,000 | 20,000 | 20,000 | 17,000 | 24,000 | 27,000 | 15,000 | 15,000 | 16,000 |
| modulus | | | | | | | | | |
| (kgf/cm²) | | | | | | | | | |
| Impact | 5.8 | 8.2 | 7.2 | 7.5 | 2.4 | 1.5 | 11 | 18 | 6.5 |
| strength | | | | | | | | | |
| (kg·cm/cm, | | | | | | | | | |
| room | | | | | | | | | |
| temperature) | | | | | | | | | |
| HDT before | 102 | 111 | 98 | 97 | 115 | 68 | 82 | 64 | 88 |
| aging (° C.) | | | | | | | | | |
| HDT after | 112 | 118 | 113 | 106 | 122 | 82 | 104 | 87 | 95 |
| aging (° C.) | | | | | | | | | |

As seen from the results of Examples and Comparative examples shown in the above tables 1 and 2, it can be found out that the polypropylene/polylactic acid resin compositions of Examples 1 to 5 according to the present invention showed excellent mechanical properties and HDT with good balance between them. Particularly, the specimens after the injection molding showed excellent HDT without an aging process.

Further, in Examples 1 and 2, as the amount of the reactive compatibilizer, i.e. polypropylene glycidyl methacrylate graft copolymer increases, the impact strength and HDT before/after aging of the polypropylene/polylactic acid resin composition were raised.

Still further, in Examples 3 and 4 wherein an impact modifier and an inorganic filler were further added, although the physical properties were slightly lower than those resulted from Examples 1 and 2, the physical properties thereof overall were excellent. In Example 5 wherein only a reactive compatibilizer was added without an impact modifier, HDT was excellent.

The comparative example wherein the content of a polylactic acid resin was the highest, showed some excellent mechanical properties such as tensile strength and flexural modulus, however both of impact strength and HDT were rapidly deteriorated.

Further, Comparative example 2 wherein 22 parts by weight of an impact modifier were added, showed good impact strength, however HDT was relatively lowered.

Comparative example 3 wherein a polyethylene glycidyl methacrylate copolymer was used as a compatibilizer, instead of a polypropylene glycidyl methacrylate graft copolymer, showed the most excellent impact strength, however, HDT before aging was significantly lowered.

Comparative example 4 wherein a polypropylene-maleic anhydride copolymer was used as a compatibilizer, showed generally decreased physical properties as compared to Example 4.

Summing up the results as represented above, the polypropylene/polylactic acid resin composition according to the present invention has excellent and well-balanced mechanical properties, and particularly excellent heat resistance even without aging, thereby being suitably used in manufacture of various products including automobile and electric or electronic parts.

### INDUSTRIAL AVAILABILITY

According to the present invention, it is possible to obtain a polypropylene resin composition containing a polylactic acid resin having high heat resistance even without an aging process as well as excellent mechanical properties such as impact resistance and flexural modulus. When it is applied to automobile parts, electric or electronic parts, it brings up various advantages such as considerable improvement in productivity as it may be applied to a desired product without an aging process after injection molding, and carbon dioxide gas reduction, in the aspect of environment protection, owing to the use of eco-friendly material, polylactic acid.

1-8. (canceled)

9. A polypropylene resin composition comprising:
(A) 40-80 parts by weight of a polypropylene resin,
(B) 10-45 parts by weight of a polylactic acid resin, and
(C) 3-30 parts by weight of a reactive compatibilizer according to the following general formula: 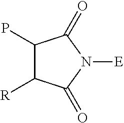
wherein,
P is polypropylene;
R is a saturated or unsaturated C₁₋₅ hydrocarbon chain; and
E is a C₁₋₁₀ hydroxyalkyl, aminoalkyl or carboxyalkyl.

10. The polypropylene resin composition according to claim 9, further comprising:
(D) 20 parts by weight or less of an impact modifier, and
(E) 20 parts by weight or less of an inorganic filler.

11. The polypropylene resin composition according to claim 9, wherein the polypropylene resin is at least one selected from the group consisting of a propylene homopolymer, a propylene block copolymer, and a propylene random copolymer, wherein the melt index of the polypropylene resin is preferably 0.5-30 grams/10 min (American Society for Testing and Materials (ASTM) D1238, 230° C., 2.16 kg).

12. The polypropylene resin composition according to claim 9, wherein the polylactic acid resin is at least one selected from the group consisting of poly-L-lactic acid, poly-D-lactic acid, and poly-(D,L)-lactic acid, wherein the weight average molecular weight of the polylactic acid is in the range of 50,000-400,000 grams/mole.

13. The polypropylene resin composition according to claim 9, wherein the reactive compatibilizer is at least one selected from the group consisting of a polypropylene-glycidyl methacrylate graft copolymer, a polypropylene-N-(hydroxyalkyl)maleimide graft copolymer, a polypropylene-N-(carboxyalkyl)maleimide graft copolymer, and a polypropylene-N-(aminoalkyl)maleimide graft copolymer.

14. The polypropylene resin composition according to claim 10, wherein the impact modifier is at least one selected from the group consisting of an amorphous ethylene-α-olefin copolymer, an ethylene propylene diene copolymer (EPDM), a styrene thermoplastic elastomer, and acryl copolymer.

15. The polypropylene resin composition according to claim 10, wherein the inorganic filler is at least one selected from the group consisting of talc, clay, calcium carbonate, glass fiber, mica, wollastonite, and silica.

16. The polypropylene resin composition according to claim 9, wherein the heat deflection temperature (American Society for Testing and Materials (ASTM) D648) of the composition before aging is 90° C. or more.

17. The polypropylene resin composition according to claim 10, wherein the polypropylene resin is at least one selected from the group consisting of a propylene homopolymer, a propylene block copolymer, and a propylene random copolymer, wherein the melt index of the polypropylene resin is preferably 0.5-30 grams/10 min (American Society for Testing and Materials (ASTM) D1238, 230° C., 2.16 kg).

18. The polypropylene resin composition according to claim 10, wherein the polylactic acid resin is at least one selected from the group consisting of poly-L-lactic acid, poly-D-lactic acid, and poly-(D,L)-lactic acid, wherein the weight average molecular weight of the polylactic acid is in the range of 50,000-400,000 grams/mole.

19. The polypropylene resin composition according to claim 10, wherein the reactive compatibilizer is at least one selected from the group consisting of a polypropylene-glycidyl methacrylate graft copolymer, a polypropylene-N-(hydroxyalkyl)maleimide graft copolymer, a polypropylene-N-(carboxyalkyl)maleimide graft copolymer, and a polypropylene-N-(aminoalkyl)maleimide graft copolymer.

20. The polypropylene resin composition according to claim 10, wherein the heat deflection temperature (American Society for Testing and Materials (ASTM) D648) of the composition before aging is 90° C. or more.
